(19) United States
(12) Patent Application Publication
(10) Pub. No.: US 2004/0148052 A1
(43) Pub. Date: Jul. 29, 2004

(54) Hazardous materials shipping system, method and computer program product

(75) Inventors: Jerome W. Ferguson, Princeton, NJ (US); Benito Chua, Edison, NJ (US); Richard West, Morris Plains, NJ (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service

(21) Appl. No.: 10/350,916

(22) Filed: Jan. 25, 2003

(51) Int. Cl. G06F 7/00

(52) U.S. Cl. 700/213

(57) ABSTRACT

A hazardous materials shipping system for tracking a plurality of packages containing hazardous materials. The shipping system includes a shipment order system configured to record shipping and hazardous materials information, and to issue a tracking number for the package. A package tracking system tracks a path of the package through various delivery vehicles and other facilities. Information on the hazardous materials can be correlated with the delivery path of the package by a hazardous materials database system using the tracking number. Optionally, the hazardous materials database system can make the delivery path and hazardous materials information available to an emergency response team to facilitate containment and cleanup of hazardous materials along the path. As another advantage, the hazardous materials database system can compare the paths of various packages to determine if cross-contamination has occurred.

### BACKGROUND OF THE INVENTION

1. Field of the Invention

The present invention is related to the field of hazardous materials management systems, and in particular to hazardous material management systems including shipment of hazardous materials.

2. Description of Related Art

To comply with local, state and other laws, hazardous materials require special handling, documentation, and record retention procedures. Conventional hazardous material handling systems use primarily paper-based document systems that require completion and exchange of paper forms and records. Although hazardous material packages are shipped using electronic tracking numbers, documentation for the packages, such as the type of materials contained in the packages, handling instructions, etc., are maintained in paper form.

Paper documentation presents several problems with regard to auditing of the packages, and with respect to archiving and retrieval of shipment documents. For instance, various laws can require that the contents of each package be audited at certain locations or times. With conventional paper-based systems, the auditor has to be present at the location of the package because the only record of the contents of the package are attached to the package. Difficulties may also arise in accidents where emergency response personnel need information about the hazardous materials contained in the package in order to properly contain, neutralize or otherwise handle, or dispose of, the hazardous materials.

Such problems have been partially addressed in prior art systems that use electronic databases to store hazardous materials information. For instance, U.S. Pat. No. 6,397,115 to Basden (“Basden”) discloses a hazardous material classification system. As shown in FIG. 2, the system is embodied in a computer program having three modules, scheduling 28, classification 30 and packaging 32. The scheduling module contains descriptions of customer requests and predicts fulfillment dates of the requests depending upon when the ordered resources are available. The classification module automatically classifies various materials based on the compound, sender, catalog number and compound code.

Non-automatic classification can also be performed which includes searching for particular compounds based on name or catalog number, and also includes auditing of the automatic classification. The packaging module includes a labeling component that determines the marking and labeling requirements for the package and provides the appropriate label based on the material classification. The packaging module also generates various shipping documents 57. Once packaging is complete, and if the package is not being delivered internally, the package is shipped via a designated carrier 68.

Also after packaging is complete, a report generation subsystem 34 may be used to generate multiple reports including reports containing emergency information. Basden describes use of the system in an emergency incident management situation where a package is found leaking at an airport. The only legible portion of the label indicates that the box originated from “Company X” and that the package includes hazardous materials. The airport authorities contact Company X, which accesses the system 10 to search the database for packages with similar shipping dates and searches each record. Once the record of the shipment is identified, the handling precautions are determined and communicated to the airport authorities in France.

Despite the advantages of the system taught by Basden, it may be difficult, or impossible, to identify the tracking number of the packages if the package has been destroyed or damaged. The package labels may be missing or illegible, or the danger of contamination of workers or emergency personnel may preclude close inspection of the packages. Such difficulties could slow the response times of emergency personnel needing information about the hazardous materials in order to effectively contain and dispose of the materials.

Therefore, it would be advantageous to have a database and system for electronically storing, and retrieving, information about hazardous materials being shipped in packages. It would be further advantageous to have a system for making such information available to emergency response personnel. It would also be advantageous if the system were capable of identifying the contents of damaged or relatively unidentifiable packages.

### BRIEF SUMMARY OF THE INVENTION

The present invention addresses the above needs and achieves other advantages by providing a hazardous materials shipping system for tracking a plurality of packages containing hazardous materials. The shipping system includes a shipment order system configured to record shipping and hazardous materials information, and to issue a tracking number for the package. A package tracking system tracks a path of the package through various delivery vehicles and other facilities. Information on the hazardous materials can be correlated with the delivery path of the package by a hazardous materials database system using the tracking number. Optionally, the hazardous materials database system can make the delivery path (via a series of recorded locations) and hazardous materials information available to an emergency response team to facilitate containment and cleanup of hazardous materials upon request. As another advantage, the hazardous materials database system can compare the paths of various packages by identifying shared locations to determine if cross-contamination has occurred.

In one embodiment, the present invention includes a shipping system that includes information pertaining to packages containing hazardous materials. Included in the system is a shipment order system that is configured to record shipping information and hazardous materials information submitted by the shipping party for delivery of a package. The hazardous materials information describes the hazardous materials contained in the package. In addition to collecting the shipping and hazardous materials information, the shipment order system is configured to generate a tracking number corresponding to the package. Further included in the hazardous materials shipping system is a package tracking system that includes a plurality of package and facility identification devices. Each of the identification devices is located at a respective one of a plurality of facilities encountered by the package along a delivery path. Each of the identification devices is capable of recording the tracking number of the package and of the respective facility through which the package passes at each encounter. A hazardous materials database system is connected in communication with the shipment order system and the package tracking system. The hazardous materials database system is configured to match the package tracking number generated by the shipment order system with recordings of the package tracking number by the package tracking system. In this manner, the hazardous materials information is correlated with the delivery path of the package.

Optionally, the hazardous materials database system may include an emergency response system that is capable of communicating the hazardous materials information and the delivery path of the package to emergency personnel. As another option, the hazardous materials database system may also be capable of communicating the hazardous materials information to auditing personnel at one of the facilities along the delivery path.

The facilities at which the identification devices are located can include static facilities, such as a hub location for sorting and processing of packages, or can include various movements or vehicles, such as trucks, trains or cargo planes. In an instance where a hub location is used, the hub location preferably includes at least one designated area in which an audit terminal is located. The audit terminal is connected in communication with the hazardous materials database system and is configured to obtain and display the hazardous material information to the auditor.

In another aspect, the emergency response system includes personnel for reviewing and distributing the hazardous materials information and delivery path to the emergency personnel. To facilitate review and distribution by the personnel, the hazardous materials database system can include a searchable database containing the tracking numbers, hazardous materials information and delivery paths of a plurality of packages. Alternatively, such a database could be directly accessible over a network by the emergency personnel.

In yet another aspect, the hazardous materials database system is further configured to determine overlap between the delivery path of the package and the delivery paths of other packages to detect possible cross-contamination. Overlap is determined by searching a particular location along the path to determine which other packages are present at a facility.

The present invention has many advantages, including freeing the audit process from the cumbersome use of paper documentation that slows the shipment of hazardous materials. The use of multiple terminals at various points along the delivery path of the package, and in various facilities, enables the quick retrieval of information for audit or emergency response. Information made accessible to the emergency response personnel by the system not only describes the hazardous materials in the package, but also describes the specific path that the package took during delivery, including which facilities (trucks, trains, planes, hubs, etc.) the package passed through. Such information is especially advantageous to determine which facilities require cleanup and decontamination in the case of a leakage of hazardous materials that is not immediately detected.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram of a hazardous materials shipping system of one embodiment of the present invention;

FIG. 2 is a schematic diagram of a hazardous materials information system of another embodiment of the present invention;

FIG. 3 is a flowchart of a method of collecting and reporting hazardous materials information for auditing and emergency response of another embodiment of the present invention;

FIG. 4 is a tracking number entry GUI displayed by the system of FIG. 2;

FIG. 5 is a package audit GUI displayed by the system of FIG. 2;

FIG. 6 is a vehicle identification number search GUI displayed by the system of FIG. 2; and

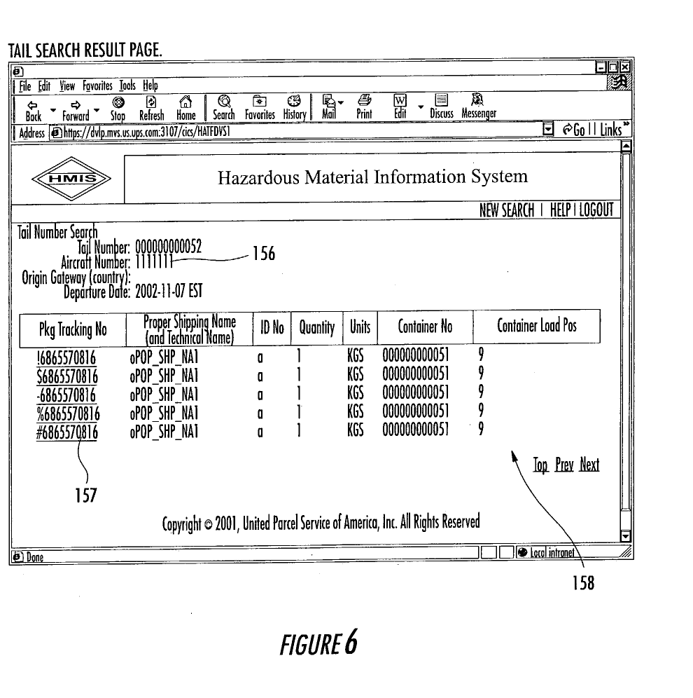

FIG. 7 is a package detail GUI displayed by the system of FIG. 2 and including tracking and hazardous materials information.

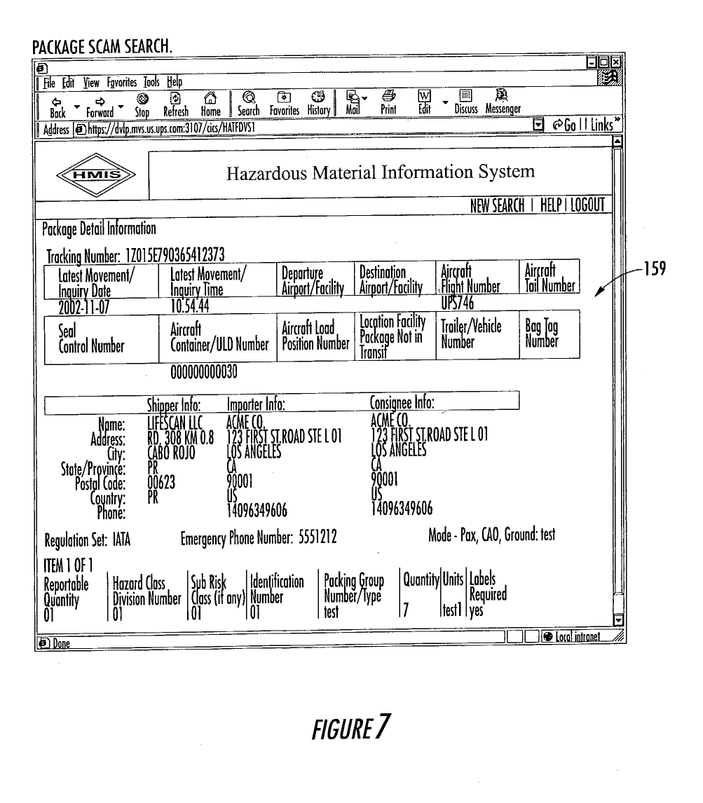

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

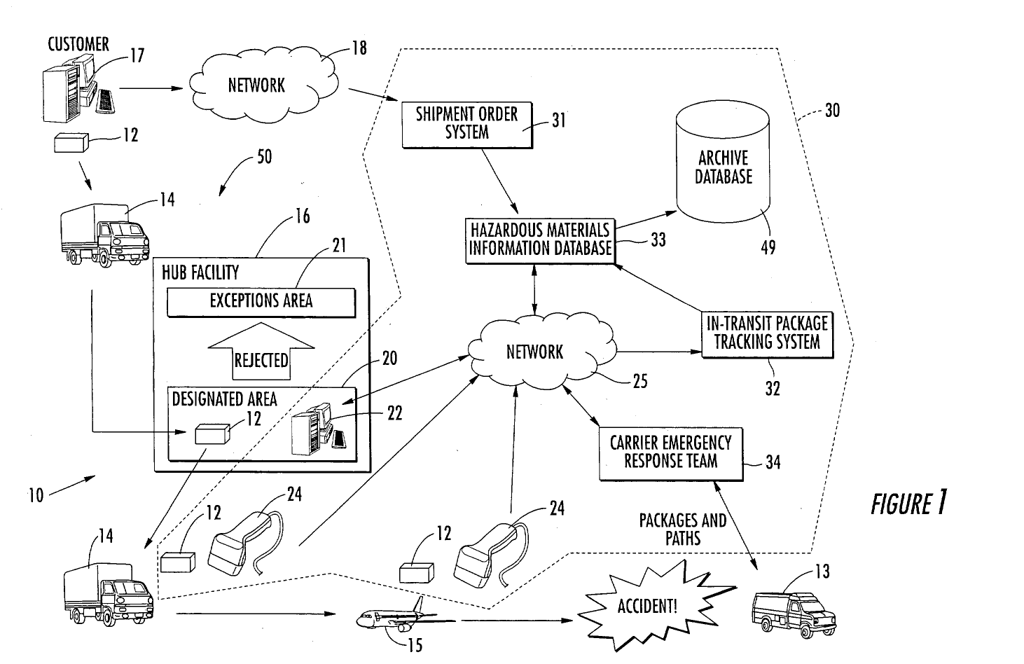

In one embodiment, the present invention includes a hazardous materials shipping system 10, as shown schematically in FIG. 1. The hazardous materials shipping system includes a hazardous materials information system 30 that cooperates with a physical delivery system 50 to deliver packages containing hazardous materials. Contained within the hazardous materials information system 30 is a shipping (or shipment) order system 31, an in-transit package tracking system 32, a hazardous materials information database 33 and a carrier emergency response team 34.

Generally, the shipping order system 31 is capable of receiving and processing shipping orders from customers, wherein the orders include shipping information and hazardous materials information on the contents of a package 12, and issues a tracking number (i.e., a code such as an alphanumeric sequence) for the package. The delivery system 50 is capable of conducting delivery of the package 12 and includes various vehicles, hubs, personnel and other facilities for physically delivering the package. The package tracking system 32 is capable of tracking the progress of delivery of the package 12 by the delivery system 50 throughout its route until the package reaches its final destination.

The hazardous materials information database 33 is in communication with the shipping order system and the package tracking system, allowing it to cross-reference the information from the order and tracking systems using the tracking number to determine the contents, and path of travel, of each package 12. Information on the contents and path of travel of the package can then be communicated to, or accessed by, auditors for determining compliance with various hazardous materials regulations and by emergency personnel 13 for cleanup and decontamination throughout various shipping facilities.

In greater detail, the delivery system 50 of the embodiment schematically illustrated in FIG. 1 shows various shipping facilities including delivery trucks 14, a cargo plane 15 and a hub facility 16. It should be noted that the broad aspects of such delivery systems are conventional in the art and are therefore not depicted in more detail herein. For instance, the number of trucks, planes, and other movements, necessary to deliver the package will vary due to the size, timing of delivery, origin location, destination location, etc., of the package 12. In addition, such factors, and the type of hazardous materials contained in the package, will influence the number of hubs, and other processing locations, required for proper, timely delivery of the package. Therefore, the present invention should be considered to apply to various delivery systems with varying numbers of delivery vehicles, personnel, hubs, locations, processes and other facilities.

It should also be noted that the terms “facilities” or “shipping facilities” as used herein are defined as any moveable or static location at which contamination from hazardous materials in the package 12 may occur. For instance, contamination may occur in a hub facility at which unloading, sorting and other processing duties are being conducted. As another example, such a location may merely be a parking lot or loading point, or other more informal location, at which transfer of packages from one movement to another movement is occurring. Also, shipping facilities may refer to any type of “movement,” which as used herein refers to any type of delivery vehicle or process, including planes, train cars, trucks, ships, or other equipment that comes into contact with the packages.

The shipping hub facility 16, as illustrated schematically in the embodiment of FIG. 1, includes a designated area 20 for receiving packages containing hazardous materials that, under various laws and regulations, must be audited. Also, the facility 16 includes an exceptions area 21 to which packages that have failed the audit are sent for containment, further auditing or to wait for pickup and return to the customer. Notably, the designated area does not need to be in a hub facility, and could be any facility formally, or informally, selected or designated for receipt and audit of packages containing hazardous materials. The designated area 20 of the hub facility may include an audit terminal 22, which is preferably a computer equipped with software for retrieving information from the hazardous materials information system 30, as will be described in more detail below. The audit terminal 22 could also be considered part of the hazardous materials information system.

The shipping order system 31 is connected via a network 18 to a customer computer 17. In the embodiment illustrated schematically in FIG. 1, the customer computer 17 includes software that interacts with the customer to obtain orders for shipping packages, and in particular, orders for shipping packages containing hazardous materials. Such software is typically capable of displaying various graphical-user-interface (GUI) screens having fields or selections for input by the customer of shipping and hazardous materials information. Generally, the shipping order system 31 facilitates pickup, processing and delivery of the package 12 by supplying the shipping information obtained from the customer computer 17 to the delivery system 50.

It should be noted that the shipping order software resident on the customer computer 17, and the intervening network 25, could also be considered part of the shipping order system 31. Alternatively, the shipping order software could be resident on other computers or electronic terminals, such as at facilities of the carrier or at a retail outlet that sells shipping services. In still other alternatives, the shipping order system may be executed manually, such as via paper documentation, or via public telephone network wherein personnel speaking to the customer enter the order on carrier-owned computers, or combinations of various electronic and manual systems.

Shipping information preferably includes an origin location, destination location, shipping method (overnight, ground, air, etc.), package weight and billing code. In addition, or alternatively, the shipping information may also include any type of information that allows or facilitates delivery of the package by the delivery system. The hazardous materials information typically includes a description and quantity of the materials in the package (e.g., Paint, 5L), an emergency contact number and standard hazardous materials identification or classification codes. Hazardous materials information can also include other types of information, as desired, or as required by law, regulation, or general safety concerns.

The shipping software on the customer computer 17 is capable of communicating the shipping and hazardous materials information over the network 18 (such as the Internet) to the shipping order system 31. The shipping order system 31 is preferably an electronic system capable of generating a unique tracking number, associating the tracking number with the shipping and hazardous materials information, storing the tracking number and associated shipping and hazardous materials information on a relatively short-term database and reporting the tracking number over the network 18 to the customer computer 17. The customer computer 17 optionally includes a printer for printing labels describing the shipping information and the tracking number, and may also include some or all of the hazardous materials information.

The package tracking system 32 is connected via another network 24 to a plurality of scanning devices 24 at various locations along the path of delivery of the package 12. Two of the scanning devices 24 are shown in FIG. 1, one of which is associated with one of the delivery trucks 14 and the other which is associated with the cargo plane 15. The scanning devices 24 and network 25 could also be considered part of the package tracking system 32. The scanning devices could be electronic identification devices, such as barcode scanners or other electronic pattern-recognition devices, or could be non-electronic identification devices, such as carrier personnel reading the tracking number and manually entering the number into a data entry device. The scanning devices could also be RF-Tag readers, in which case, the tracking and other information concerning the package are stored in an RF-Tag on the package.

Each of the scanning devices 24 is positioned to record the tracking number of the packages being loaded onto the movement (truck, plane, etc.) and can also be used to record a vehicle identification number (e.g., a code such as an alphanumeric sequence) which identifies the movement. For instance, the truck or plane may itself be equipped with the scanner that records each of the packages as they are loaded onto the movement and transmits the package tracking numbers, and the vehicle identification number, over the network 25 to the in-transit package tracking system 32. In this alternative, the network 25 is preferably wireless at its front end to allow transmission from the movement regardless of position. Other scanning devices 24 could also be positioned at static shipping facilities, such as the hub facility 16, that allows recording and transmission of package tracking numbers and a facility identification number to the in-transit package tracking system 32. Still other scanning devices 24 could be positioned at pickup or drop-off locations where the package 12 is initially submitted to the delivery system. In addition to identifying the vehicle itself, portions of the vehicle or movement may also have identification numbers. For instance, in the case of a train, each of the individual containers, or cars, may have identification numbers in lieu of, or in addition to, the train's identification number.

The package tracking system 32 is preferably an electronic system that constructs and stores a timeline of the identification numbers of the various facilities, such as the trucks 14, hubs and other vehicles, through which the package 12 has passed by referencing the scanned tracking number of the package. The package tracking system may have its own database correlating the facility identification numbers with the actual facility locations and specific delivery vehicles and other movements, or may consult a separate database or system containing such information.

The hazardous materials information database 33 is connected in communication (such as via a local area network) with the shipping order system 31 and the package tracking system 32 allowing information to be passed between the systems. A connection to the shipping order system 31 allows the hazardous materials information database 33 to retrieve, or receive, the shipping information, hazardous materials information and associated package tracking numbers from the shipping order system. Further, the connection to the package tracking system 32 allows the hazardous materials database 33 to obtain path information corresponding to the package tracking numbers. Resident on the database 33, or as part of an associated system, are software applications or modules that match the shipping information, hazardous materials information and the path information (i.e., each of the facilities on which the package 12 has traveled and is currently traveling) to form a complete record which is stored on the database.

Preferably, the database 33 is configured to allow searching and sorting (e.g., by the audit terminal 22 or a terminal accessible by the carrier emergency response team 34) of all of the package records based on a common search term such as the type of hazardous material and current location in a facility. Alternatively, searches could be run to determine overlap between package paths by searching for all packages a common facility in a limited timeframe. Such searches would be useful in instances where occupation of the same facility by a package leaking hazardous materials could have contaminated other packages within that facility. The hazardous materials information system 30 may also include an archive database 49 that includes a duplicate of the entries compiled by the database 33 but having long-term storage capabilities in cases where laws and regulations require retention of hazardous materials records over long time periods, such as several years.

The carrier emergency response team 34 includes a team of personnel designated by the carrier to respond to an accident (vehicle wreck), or other incident (detection of a package leak), in which cleanup and/or containment of the package 12 and the various facilities and/or other packages is necessary. If such an accident occurs, the emergency response team 34 is typically contacted by the emergency personnel 13 wishing to identify the contents of various packages to determine the presence of hazardous materials, the type of hazardous materials and other information to assist in cleanup.

Preferably, the emergency response team 34 has its own terminal, or other input and display device(s), enabling the personnel to access the hazardous materials information database 33 and search for all the packages located at the facility involved in the incident. In the case of the incident being leakage of the package, or other incident in which knowledge of the package's path is useful, the path of the package is also determined. Once determined, the information can then be audited by the response team 34 personnel and communicated to the emergency personnel 13 for subsequent cleanup or containment activities.

As an alternative to the carrier emergency response team 34, the emergency personnel 13 may have direct access to the database 33 via the network 25. Access to the database 33 may be limited by security software that requires entry of passwords, or other confidential identification information, and may further limit the type of information that is accessible by the emergency personnel 13 in order to maintain confidentiality of other shipments not involved in the incident. It should be noted that the term “network” as used herein should be construed broadly to include all types of electronically assisted communication such as wireless networks, local area networks, public networks such as the Internet, public telephone networks, or various combinations of different networks. Similarly, terminal as used herein can be any display or input device including desktop computers, PDA, laptop computers, etc.

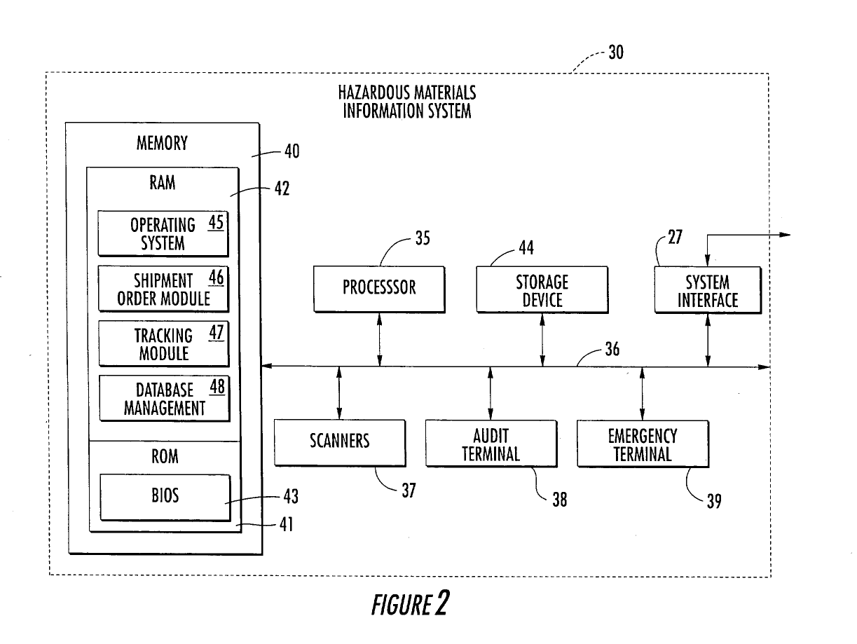

The hazardous materials information system 30 of another embodiment of the present invention is shown in FIG. 2. The hazardous materials information system includes a processor 35 that communicates with other elements within the hazardous materials system via a system interface or bus 36. Also included in the hazardous materials information system 30 are display and input devices, including scanners 37, audit terminals 38 and emergency terminals 39 for receiving and displaying data. The hazardous materials information system 30 further includes memory 40, which preferably includes both read only memory (ROM) 41 and random access memory (RAM) 42. The ROM 41 is used to store a basic input/output system (BIOS) 43 containing the basic routines that help to transfer information between elements within the hazardous materials information system 30.

In addition, the hazardous materials information system 30 includes at least one storage device 44, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 44 is connected to the system bus by an appropriate interface. The storage devices 44 and their associated computer-readable media provide non-volatile storage for the hazardous materials information system 30. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices, such as within RAM 16 (as shown in FIG. 2) or within the storage device 44 (as not shown for clarity). Such program modules include an operating system 45, a shipment order module 46, a tracking module 47 and a database management module 48. As described both above and below, the shipment order module 46 handles recording of shipment information and hazardous materials information from the customer and issues tracking numbers for packages. The tracking module 47 records and stores an ongoing list of the various facilities through which the package 12 passes along its delivery path. The database management module 48 obtains information from the other systems and compiles entries into the storage device 44 that include the path of travel and hazardous materials contents of each package 12. Also, the database management module 48 provides the various search functions necessary to assist auditors and emergency personnel 13.

Also located within the hazardous materials information system 30, is a system interface 27 for interfacing and communicating with other elements of the overall shipping system 10, such as the delivery system 50. It will be appreciated by one of ordinary skill in the art that one or more of the hazardous material information system's 30 components may be located geographically remotely from other components. Furthermore, one or more of the components may be combined, and additional components performing the functions described herein may be included in the hazardous materials information system 30.

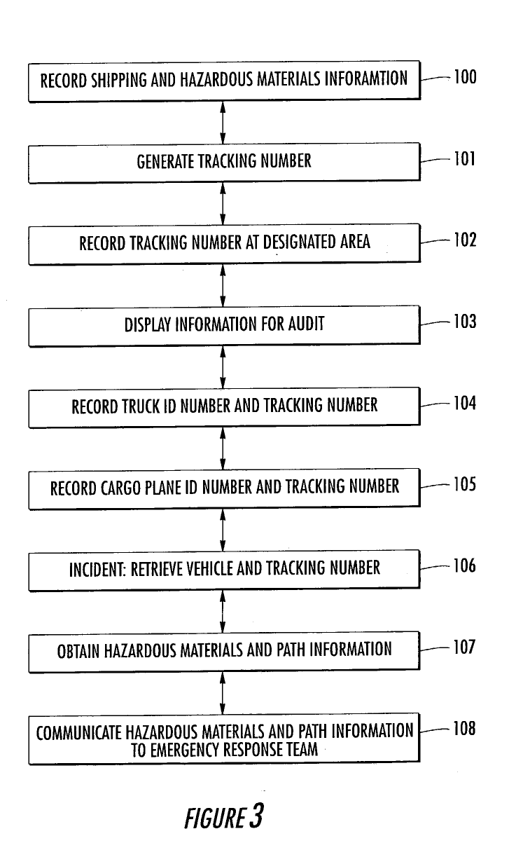

During operation of the hazardous materials information system 30, as shown in FIG. 3, the shipping order module 46 records 100 entry of shipping information and hazardous materials information by communicating over the network 18 with the customer 17. The order module 46 generates 101 a tracking number which is sent back over the network 18 to the customer computer 17 for generation of a label by the customer computer, after which the label is affixed to the package 12. The package is then submitted to the carrier delivery system 50, such as by pickup by delivery system personnel and loading of the package into the delivery truck 14, as shown in FIG. 1. Although not shown by FIG. 1, the package may be scanned upon entry into the delivery truck and the tracking number of the package 12, and identification number of the truck 14, may be wirelessly transmitted to the tracking system 32.

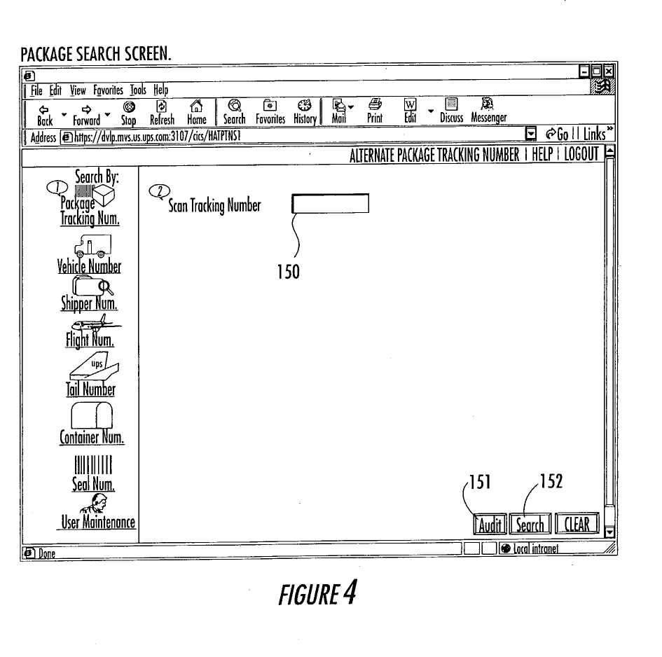

As is shown by FIGS. 1 and 3, as the package 12 enters the initial hub facility 16 it is moved to a designated area for auditing because it is marked as containing hazardous materials. An auditor selects the package 12, determines the tracking number either by reading it from the package, or by scanning a barcode on the package label with a scanning device 24 in communication with the audit terminal 22. For instance, FIG. 4 shows a GUI displayed on the terminal prompting entry or scanning 102 of the tracking number into a tracking number field 150 before selection of an audit button 151 or search button 152.

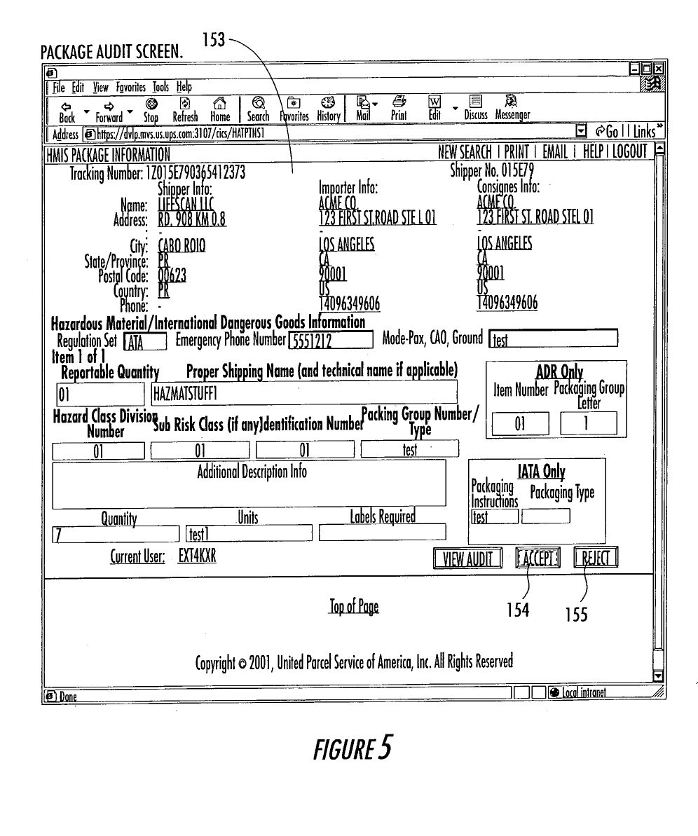

The hazardous materials database management module 48 then uses the tracking number to determine and display 103 the hazardous materials and shipping information stored on the storage device 44 corresponding to the scanned package 12, as shown by the package audit screen 153 in FIG. 5. The package audit screen includes an accept button 154 and a reject button 155. If all of the information is adjudged to be satisfactory by the auditor, the accept button 154 is selected. Alternatively, in the case of a failure to comply with laws and regulations, the reject button 155 is selected and the package is sent to the exceptions area 21 for return to the customer, or submission of further information by the customer.

Once accepted, the package 12 is released for pickup by another delivery truck 14 at which point it is scanned by the scanner 37 and the tracking number and vehicle identification number are collected 104 by the tracking module 47. Similarly, the package is delivered by the truck 14 for loading into the cargo plane 15 at which point it is again scanned by another scanner 37 and the tracking number and plane's vehicle identification number are collected 105 by the tracking module 47. Collection of tracking information, of course, can occur multiple times along the delivery path of the package 12 and shouldn't be considered limited to the movement types, and other facilities, in the illustrated embodiments. As the tracking information is collected, it is saved to the storage device.

If an incident, such as a vehicle accident or detection of a leaking package, occurs, the carrier's emergency response team 34 responds by accessing the emergency terminal 39 and requesting a search of the storage device 44. The database management module 48 retrieves 106 either the vehicle identification number, in the case of a vehicle accident, or the package tracking number in the case of a leaking package. The database management module 48 then either searches the entries it has already constructed, or constructs the entries by matching 107 tracking numbers of the packages with the package paths and the hazardous materials information. Alternatively, matching may also include a search of the vehicle number to identify all the packages, and associated hazardous materials information, present on the vehicle that is involved in the accident. Other search terms that may be used include aircraft tail number, flight number, hazardous materials contents or classification, shipping information (shipper, consignee, origin and destination locations, etc.), departure date, etc.

Once the information has been determined by the database management module 48, the hazardous materials, shipping, path and other information is communicated 108 to the emergency response team 34 by display on the emergency terminal 39. For instance, a search via vehicle identification number 156 resulting in a list of package tracking numbers 157 on a search results screen or GUI 158. Additional information on each package is revealed on a package detail GUI 159, including the hazardous materials and shipping information. This information is then reviewed and submitted to the emergency personnel 13 which use the information to facilitate cleanup or containment.

FIGS. 1-3 are block diagrams, flowcharts and control flow illustrations of methods, systems and program products according to the invention. It will be understood that each block or step of the block diagram, flowchart and control flow illustration, and combinations of blocks in the block diagram, flowchart and control flow illustration, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustration support combinations of means for performing the specified functions, combinations of steps for performing the specified functions and program instruction means for performing the specified functions. It will also be understood that each block or step of the block diagram, flowchart or control flow illustration, and combinations of blocks or steps in the block diagram, flowchart or control flow illustration, can be implemented by special purpose hardware-based computer systems which perform the specified functions or steps, or combinations of special purpose hardware and computer instructions.

The present invention has many advantages, including freeing the audit process from the cumbersome use of paper documentation that slows the shipment of hazardous materials. The use of multiple terminals 22, 38, 39 at various points along the delivery path of the package 12, and in various facilities, facilitates the quick retrieval of information for audit or emergency response. Information made accessible to the emergency response personnel 13 by the system 30 not only describes the hazardous materials in the package 12, but also describes the specific path that the package took during delivery, including which facilities (trucks, trains, planes, hubs, etc.) the package passed through. Such information is especially advantageous to determine which facilities require cleanup and decontamination in the case of a leakage of hazardous materials that is not immediately detected.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A hazardous materials shipping system for tracking a plurality packages containing hazardous materials shipped by a shipping party, said hazardous materials shipping system comprising:
a shipment order system configured to record shipping information and hazardous materials information submitted by the shipping party for delivery of a package, wherein the hazardous materials information describes the hazardous materials contained in the package, and said shipment order system further configured to generate a tracking number corresponding to the package;
a package tracking system including a plurality of package and facility identification devices wherein each of the identification devices is located at a respective one of a plurality of facilities encountered by the package along a delivery path and wherein the identification device is capable of recording the tracking number of the package and the respective facility at which the package is located at each encounter; and
a hazardous materials database system connected in communication with the shipment order system and the package tracking system, said hazardous materials database system configured to correlate the hazardous materials information with the delivery path of the package.

2. A hazardous materials shipping system of claim 1, wherein the hazardous materials database system further includes an emergency response system capable of communicating the hazardous materials information and the delivery path of the package to emergency personnel.

3. A hazardous materials shipping system of claim 2, wherein the hazardous materials database system further includes an audit system capable of communicating the hazardous materials information to auditing personnel at one of the facilities along the delivery path.

4. A hazardous materials shipping system of claim 3, wherein the facilities include a plurality of movements and at least one hub location.

5. A hazardous materials shipping system of claim 4, wherein the hub location includes at least one designated area at which an audit terminal is located, said audit terminal connected in communication with the hazardous materials database system and configured to display the hazardous materials information.

6. A hazardous materials shipping system of claim 2, wherein the emergency response system includes personnel capable of reviewing and distributing the hazardous materials information and delivery path to the emergency personnel.

7. A hazardous materials shipping system of claim 6, wherein the hazardous materials database system further includes a searchable database comprising at least tracking numbers, hazardous materials information, and delivery paths of a plurality of packages and wherein the database is accessible by the personnel.

8. A hazardous materials shipping system of claim 2, wherein the emergency response system includes a network accessible computer system configured to electronically transmit the hazardous materials information and delivery path to the emergency personnel

9. A hazardous materials shipping system of claim 1, wherein the hazardous materials database system is further configured to identify other packages at one facility along the path of the package.

10. A method of providing information on hazardous materials contained in a package to emergency personnel, said method comprising:
recording shipping information pertaining to the package and hazardous materials information describing the hazardous materials in the package;
generating a tracking number corresponding to the package;
tracking a delivery path of the package by recording the tracking number at encounters of the package with shipping facilities; and
correlating the hazardous materials information of the package with the delivery path of the package using the tracking number.

11. A method of claim 10, further comprising reporting the delivery path and the hazardous materials information to the emergency personnel in response to an incident involving the package.

12. A method of claim 11, further comprising reporting the hazardous materials to an auditor.

13. A method of claim 11, further comprising identifying other packages at one facility along the path of the package and wherein reporting further includes reporting the identity of the other packages.

14. A computer program software product for providing information on hazardous materials contained in a package to emergency personnel, comprising:
a first executable portion configured to record shipping information pertaining to the package and hazardous materials information describing the hazardous materials in the package;
a second executable portion configured to generate a tracking number corresponding to the package;
a third executable portion configured to track a delivery path of the package by recording the tracking number at encounters of the package with shipping facilities; and
a fourth executable portion configured to correlate the hazardous materials information of the package with the delivery path of the package using the tracking number.

15. A computer software program product of claim 14, further comprising a fifth executable portion configured to report the delivery path and the hazardous materials information to the emergency personnel in response to an incident involving the package.

16. A computer software program product of claim 14, further comprising a sixth executable portion configured to report the hazardous materials information to an auditor.

17. A computer software program product of claim 14, further comprising a sixth executable portion configured to identify other packages at one facility along the path of the package.
